(19) United States
(12) Patent Application Publication
(10) Pub. No.: US 2012/0273718 A1
(43) Pub. Date: Nov. 1, 2012

(54) HIGH-SPEED CROSS-LINKING SYSTEM

(75) Inventors: Laurent Keromnes, Chaponost (FR); Samuel Devisme, Rouen (FR); Catherine Corfias-Zuccalli, Pont-audemer (FR)

(73) Assignee: Arkema France, Colombes (FR)

(21) Appl. No.: 13/513,075

(22) PCT Filed: Nov. 24, 2010
(86) PCT No.: PCT/FR2010/052498

§ 371 Date: Jul. 19, 2012

(30) Foreign Application Priority Data
Dec. 3, 2009 (FR) 0958621

(51) Int. Cl. C08F 255/02; C09K 3/00

(52) U.S. Cl. 252/182.28; 252/182.23; 525/263; 525/265

(57) ABSTRACT

A cross-linking system which includes at least; one organic peroxide having a half-life of one hour at any temperature selected in the range from 80 DEG C. to 115 DEG C., and a cross-linking coagent, the half-life of said peroxide being measured by dissolving the peroxide in n-dodecane having a concentration of 0.2 mol/l. Said system enables, when added to a polymer, quick cross-linking of said polymer. The system is in particular suitable for encapsulating photovoltaic modules; in particular, the system can be used to improve the productivity of the method for manufacturing said modules.

### FIELD OF THE INVENTION

The subject of the invention is a crosslinking system comprising an organic peroxide and a crosslinking coagent. The invention relates more particularly to a composition comprising a polyolefin and the crosslinking system as well as the use of this composition as encapsulant for photovoltaic cells.

### STATE OF THE ART

Organic peroxides are commonly used for the crosslinking of thermoplastic resins or elastomers, these resins and elastomers being grouped together in the present description under the term “polymers”. In order to crosslink a polymer, a peroxide is generally mixed with the polymer to be crosslinked in a first step, and then a second step of shaping the polymer is carried out and then a third step of crosslinking is carried out, for example by a heat treatment.

At room temperature, peroxides may be in liquid or solid form. When peroxides are mixed with these polymers, they are mixed at high temperature, that is to say a temperature greater than the softening point of the polymer, for example by extrusion or kneading; the peroxides are then generally in a liquid form.

Moreover, photovoltaic modules comprise light-sensitive cells, called “photovoltaic cells”, which are capable of converting light to current. These cells are protected from their surroundings (moisture, oxygen, and the like) by bottom and top protective layers. These layers are generally made of glass or of polymer. One or more layers of encapsulating composition, which is often applied in the form of a film, make it possible to assemble the cells and the protective layers. The encapsulating composition must perfectly take the shape of the space existing between the cells and the other protective layers of the module, this being in order to avoid the presence of air which limits the yield of the photovoltaic module.

It is also advantageous for the composition to be sufficiently transparent to visible light in order to allow a good yield of the photovoltaic cells.

Furthermore, the top protective layer made of transparent glass or plastic is placed on top of the layer of encapsulating composition. Now, the weight of this protective layer on this film may be great: it is therefore also preferable for the composition to have good creep resistance so that the thickness of the layer is preserved over time, this being in order to improve the shelf life of the module.

This encapsulating composition is generally a composition comprising a polymer, generally an ethylene and vinyl acetate copolymer, which is crosslinked by an organic peroxide. The various constituent layers of the panel are assembled (cells, layer(s) of encapsulant comprising peroxide, protective layers) and the panel thus assembled is subjected to a curing step allowing the crosslinking of the layer of encapsulant.

Reference may be made for example to the Handbook of Photovoltaic Science and Engineering, Wiley, 2003, which describes the operation and the composition of photovoltaic modules.

Moreover, one of the problems encountered by industrial manufacturers of photovoltaic modules is that this curing step reduces the yield of the process for the manufacture of the modules. Another problem is also that it is advantageous to reduce the temperature of the curing step in order to reduce the consumption of energy necessary for the manufacture of photovoltaic modules.

In order to crosslink the polymer, the composition comprising the peroxide is heated in order to activate the peroxide. Bubbles may then appear during this activation. The large presence of these bubbles may be a disadvantage since they can reduce the transparency of the composition and prevent good encapsulation of the cells.

It is therefore necessary to find novel solutions which make it possible to improve the yields of the processes for the manufacture of photovoltaic modules. This is precisely one of the objects of the present invention which consists in the use of specific peroxides in photovoltaic modules.

### SUMMARY OF THE INVENTION

The subject of the invention is more particularly a system for the crosslinking of an ethylene copolymer and an ethylene monomer bearing a polar functional group comprising at least:
one organic peroxide whose half-life at a given temperature chosen in the range from 80° C. to 115° C. is equal to one hour;
and one crosslinking coagent;
   the half-life of said peroxide being measured by dissolving it in n-dodecane at a concentration of 0.2 mol/L.

The use of this system is particularly advantageous because it allows, when it is added to a polyolefin comprising a polar comonomer, rapid crosslinking of this polymer. When this polymer is used as encapsulant for photovoltaic modules with their system according to the invention, the yields for the processes for the manufacture of said modules are excellent and the polymer thus crosslinked has final properties which are completely suited to the encapsulation of the modules.

The peroxide may for example be chosen from tert-butyl 2-ethylperhexanoate, tert-amyl 2-ethylperhexanoate, 1,1-di-(tert-butylperoxy)-3,3,5-trimethylcyclohexane, bisdecanoyl peroxide and dilauroyl peroxide as crosslinking agent. Advantageously, the peroxide is tert-butyl 2-ethylperhexanoate.

The coagent, which is different from the organic peroxides, advantageously bears at least one carbamate, maleimide, acrylate, methacrylate or allyl functional group. Allyl carboxylates may be used. The coagents may be compounds of the allyl, diallyl and triallyl type. Advantageously, the crosslinking coagent is chosen from triallyl cyanurate, triallyl isocyanurate, N,N′-m-phenylenedimaleimide, triallyl trimellitate and trimethylolpropane trimethacrylate, preferably triallyl cyanurate.

The coagent is used here not to accelerate the crosslinking of the polymer but to increase the level of crosslinking. This coagent also makes it possible to reduce residual gas emission during the decomposition of these same peroxides, and ultimately reduce the number of bubbles in the encapsulating film.

Preferably, the ratio by mass of organic peroxide and crosslinking coagent is within the range from 1:10 to 10:1, most preferably from 1:3 to 3:1.

The system according to the invention may be used for the crosslinking of an ethylene copolymer and an ethylene comonomer bearing a polar functional group.

The subject of the invention is also a composition comprising at least one polymer and the crosslinking system according to the invention.

The polymer is advantageously a polyolefin, preferably a copolymer of ethylene and an ethylene monomer bearing a polar functional group, this monomer preferably comprising from 3 to 20 carbon atoms, preferably from 4 to 8 atoms. The ethylene monomer may be chosen from vinyl acetate and methyl, ethyl or butyl(meth)acrylates. The ethylene copolymer of the composition according to the invention preferably comprises from 10 to 60% by mass of ethylene monomer bearing a polar functional group relative to the total mass of the copolymer, preferably from 25 to 45% by mass.

The composition according to the invention has a quantity of crosslinking system preferably within, relative to the total weight of the composition, the range from 0.1 to 10%, preferably from 1 to 5%.

Another subject of the invention is a film comprising a composition according to the invention.

A subject of the invention is also the use of the composition or of a film according to the invention, as encapsulant in a photovoltaic module.

The invention also relates to a process for the manufacture of a composition according to the invention comprising a stage for mixing organic peroxide, crosslinking coagent and polymer, it being possible for this stage to be carried out in one or more steps.

According to a very advantageous version of the process for the manufacture of the composition according to the invention, it comprises a step for mixing a master batch comprising the organic peroxide with the polymer and the crosslinking coagent.

The invention thus also relates to a master batch comprising:
a polymer, preferably a copolymer of ethylene and an ethylene monomer bearing a polar functional group;
and at least one organic peroxide chosen from peroxides having an organic peroxide whose half-life, measured by dissolving it in n-dodecane at a concentration of 0.2 mol/L, is equal to one hour for any temperature chosen from the range from 80° C. to 115° C., this peroxide being preferably chosen from tert-butyl 2-ethylperhexanoate, tert-amyl 2-ethylperhexanoate, 1,1-di-(tert-butylperoxy)-3,3,5-trimethylcyclohexane, bisdecanoyl peroxide and dilauroyl peroxide;
   the quantity by mass of peroxide being within the range from 5 to 30% relative to the total weight of the master batch, preferably from 7 to 16%.

This master batch may be advantageously manufactured by a manufacturing process comprising:
a. a step for contacting said peroxide;
b. a step for the absorption of the peroxide by the polymer in order to form a master batch;
c. a step for isolating said master batch.

Other advantages of the invention will appear in the detailed description which follows.

### DETAILED DESCRIPTION OF THE INVENTION

The subject of the invention is a crosslinking system comprising at least:
one organic peroxide whose half-life at a given temperature chosen in the range from 80° C. to 115° C., preferably from 90 to 105° C., is equal to one hour;
and one crosslinking coagent;
   the half-life of said peroxide being measured by dissolving it in n-dodecane at a concentration of 0.2 mol/L (HL).

The half-life of an organic peroxide makes it possible to determine its rate of disintegration. It is given, for a concentration in a solvent, at a given temperature and time.

By using a peroxide having this half-life, a rapid crosslinking system is obtained which makes it possible to solve at least one of the problems of the invention.

Preferably, the peroxide is chosen from tert-butyl 2-ethylperhexanoate (HL=1 h at 94° C.), tert-amyl 2-ethylperhexanoate (HL=1 h at 92° C.), 1,1-di-(tert-butylperoxy)-3,3,5-trimethylcyclohexane (HL=1 h at 115° C.), bisdecanoyl peroxide and dilauroyl peroxide, which constitute, in combination with a coagent, crosslinking systems which are particularly efficient in terms of speed and level of crosslinking.

A peroxide forms during its activation free radicals on the polymer, which allows the crosslinking of the polymer chains, without the peroxide becoming integrated into these chains. A crosslinking coagent has a function that is different from a peroxide: indeed, it is activated with the aid of a free radical initiator such as organic peroxides. Thus activated during the decomposition of the peroxide, it then forms crosslinking bridges with the polymer and is therefore integrated into the chain of the crosslinked polymer, unlike peroxides.

The coagent may be monofunctional or polyfunctional. It advantageously bears at least one carbamate, maleimide, acrylate, methacrylate or allyl functional group. They are substances which advantageously have a molar mass of less than or equal to 1000 g/mol, preferably less than or equal to 400 g/mol. Allyl carboxylates may be used. The coagents may be compounds of the allyl, diallyl and triallyl type. Advantageously, the crosslinking coagent is chosen from triallyl cyanurate, triallyl isocyanurate, N,N′-m-phenylenedimaleimide, triallyl trimellitate and trimethylolpropane trimethacrylate, preferably triallyl cyanurate.

The system may optionally comprise an organic solvent. Any type of solvent may be used. For example, solvents of the alkane, aromatic, alkene, halogenated or alcohol type are used. Preferably, the solvent molecules comprise from 1 to 12 carbon atoms. By way of example of solvent, mention may be made of decane, n-dodecane, 2,4,4-trimethylpentene, α-methylstyrene, trichloro-ethylene, toluene, benzene, ethylbenzene, (1-methylethenyl)benzene, 2-ethylhexanol, isopropanol, t-butyl alcohol or acetone. Use may also be made of a mixture of solvents, for example a mixture of the solvents listed above. Preferably, the quantity of solvent is less than or equal to 25% of the total mass of the system, or even less than or equal to 10%.

The system may be used to crosslink a polymer. Another subject of the invention is a composition comprising a polymer and the crosslinking system according to the invention. If the crosslinking system comprises a solvent, the solvent used is preferably not a solvent for the polymer to be crosslinked. The expression solvent for the copolymer is understood to mean a polymer concentration greater than or equal to 0.05 g/ml of solvent when 1 g of copolymer per ml of solvent are brought into contact for one hour at 23° C.

The polymer contained in the composition according to the invention may be any type of polymer. It is for example a polyolefin, that is to say a polymer comprising an olefin. Preferably, the olefin is an alpha-olefin having for example from 2 to 10 carbon atoms, such as for example ethylene, propylene, butene-1, hexene-1, octene-1 or decene-1.

Preferably, the polyolefin is a copolymer of ethylene and an ethylene monomer bearing a polar functional group. The expression ethylene monomer is understood to mean a monomer comprising an unsaturation liable to react with ethylene in a process by the free radical route. The expression polar functional group is understood to mean a functional group exhibiting a dipole moment, such as the amine, alcohol, urethane, acid, ester or acid or diacid anhydride functional groups. Preferably, the polar functional group is an acid, ester or acid or diacid anhydride functional group.

The ethylene monomer bearing a polar functional group preferably comprises from 3 to 20 carbon atoms, preferably from 4 to 8 carbon atoms.

By way of example of copolymer, mention may be made of copolymers of ethylene and a carboxylic acid vinyl ester, the copolymers of ethylene and an unsaturated carboxylic acid or alternatively the copolymers of ethylene and an alkyl acrylate and/or methacrylate, grouped together in the present application under the term alkyl(meth)acrylate. Advantageously, the ethylene monomer may be chosen from vinyl acetate and methyl, ethyl or butyl(meth)acrylates.

The quantity by mass of ethylene monomer relative to the total mass of the copolymer (a) may be within the range from 1 to 70%, advantageously from 10 to 60% and preferably from 20 to 45%.

According to the invention, the quantities of the various monomers present in the copolymer (a) may be measured by infrared spectroscopy using the standard ISO8985 (1998).

In order to manufacture the polyolefins, use may be made of the known so-called free radical polymerization processes usually operating at pressures between 200 and 2500 bar. These processes are carried out industrially using two main types of reactor: an autoclave type reactor or a tubular type reactor. These polymerization processes are known to a person skilled in the art and use may be made for example of the processes described in the documents FR2498609, FR2569411 and FR2569412. Persons skilled in the art know the proportions in which each of the monomers are used in order to obtain the copolymer (a) used in the invention.

These copolymers are marketed by the applicant under the trade marks EVATANE® and LOTRYL®.

The level of crosslinking of the polymer is generally quantified by measuring the gel content. This gel content may be measured using the method A of the standard ASTM D2765-01 (2006). Advantageously, the gel content of the polymer is greater than or equal to 10, preferably greater than or equal to 20, for example greater than or equal to 50.

The composition may also comprise additives or inorganic fillers. By way of example of additive, mention may be made of plasticizers, antioxidants, antiozone agents, antistatic agents, coloring materials, pigments, optical brighteners, heat stabilizers, light stabilizers and flame retardants.

Coupling agents may be advantageously added in order to improve adhesiveness on another support of the composition (I) or of the polymer to be crosslinked. It may be organic, inorganic and more preferably semi-inorganic semi-organic. Among these, mention may be made of titanates or organic silanes, such as for example monoalkyl titanates, trichlorosilanes and trialkoxysilanes. Preferably, the quantity of coupling agent is within the range from 0.05 to 5% by mass of the composition.

As fillers, mention may be made of clay, silica, talc, carbonates such as calcium carbonate and silicates such as sodium silicate.

The composition according to the invention may take the form of a film. The film according to the invention which comprises the composition preferably has a thickness ranging from 50 to 2000 microns, for example from 100 to 1000 microns. It may be manufactured by any of the methods known for film manufacturing. The film may be manufactured for example by film extrusion, calendering or by pressing.

One advantage of the composition or of the film according to the invention is that the polymer of this composition or of this film may be crosslinked by a process at a lower temperature and/or more rapidly than the compositions of the prior art, the crosslinked polymer also having a very good appearance, in particular a small number of bubbles and good creep resistance.

All these properties make it possible for the composition and the film according to the invention to be very advantageously used as encapsulant in the photovoltaic modules.

Another subject of the invention is a process for the manufacture of said composition which comprises a stage for mixing the various constituents. The composition may be manufactured by any of the techniques suitable for the manufacture of thermoplastic compositions. In particular, mention may be made of the conventional techniques for mixing thermoplastics such as kneading or extrusion. The mixing is advantageously carried out at a temperature greater than the softening temperature of the polymer, measured according to the standard ASTM E 28-99 (2004). Preferably, the temperature is also less than the decomposition temperature of the peroxide. The stage for mixing the organic peroxide, the crosslinking coagent, the optional additives and the polymer may be carried out in one or more steps, that is to say that the peroxide, the crosslinking coagent and the optional additives may be mixed simultaneously or successively with the polymer of the composition.

According to a preferred process for the manufacture of the composition, a step is carried out for mixing a master batch comprising the organic peroxide, the polymer and the crosslinking coagent. This master batch according to the invention may comprise:
a polymer;
and at least one organic peroxide chosen from peroxides having an organic peroxide whose half-life, measured by dissolving it in n-dodecane at a concentration of 0.2 mol/L, is equal to one hour for any temperature chosen from the range from 80° C. to 115° C., preferably chosen from tert-butyl 2-ethylperhexanoate, tert-amyl 2-ethylper-hexanoate, 1,1-di-(tert-butylperoxy)-3,3,5-tri-methylcyclohexane, bisdecanoyl peroxide and dilauroyl peroxide;
   the quantity by mass of peroxide being within the range from 5 to 30% relative to the total weight of the master batch, preferably from 7 to 16%.

This master batch has a very particular importance: these particular peroxides being particularly unstable, it is advantageous to be able to transport, store and handle them in this master batch form. This master batch allows rapid and risk-free crosslinking of polymers, in particular of polyolefins.

As polymer useful for the manufacture of the master batch according to the invention, use may be made of the same polymers as those already mentioned for the manufacture of the composition according to the invention, including in its preferred versions.

To manufacture this master batch, use may also be made of the same manufacturing techniques already mentioned for the manufacture of the composition, that is to say the conventional techniques for mixing thermoplastics. According to an advantageous mode of the process for the manufacture of the master batch according to the invention, the process comprises the following steps:
a. a step for contacting said peroxide with the polymer at a temperature less than the softening temperature of the polymer measured according to the standard ASTM E 28-99 (2004);
b. a step for the absorption of the peroxide by the polymer in order to form a master batch;
c. a step for isolating said master batch.

One advantage of this process is that it may be carried out at a temperature below the softening temperature of the polymer, unlike the processes in the molten state. When a master batch comprising these particular peroxides is manufactured by the techniques for mixing thermoplastics, a premature crosslinking phenomenon may be observed. Thus, as the temperature is lower with this preferred process, the phenomenon of premature crosslinking of the master batch is limited. The master batch thus obtained by this preferred process exhibits a greater transparency than a master batch obtained by the conventional techniques for thermoplastics. The invention therefore also relates to the master batch obtained by the process according to the invention. The use of this master batch allows rapid crosslinking of polymers already mentioned and allows the manufacture of a composition having final properties which are completely suited to the encapsulation of photovoltaic cells. Furthermore, the introduction of organic peroxide by a master batch is easier than the direct introduction of liquid or solid peroxide into the encapsulating polymer.

According to an advantageous mode of the process according to the invention, the polymer used for the manufacture of the master batch is in the form of particles having a mean volume of 1 to 1000 mm³, preferably of 3 to 120 mm³. The expression “particles” is understood to mean polymer pieces which may have any type of geometry, for example spherical, spheroidal or cylindrical. Preferably, at least 90% by mass of these particles have a volume within these preferred volume ranges.

In this case, the master batch is directly obtained in the form of particles. It can then be easily used as master batch. On using particles having this particular volume, the absorption of the peroxide by the copolymer is excellent and little agglomeration is observed between the particles.

According to one version of the preferred process for the manufacture of the master batch of the invention, there are several contacts or there is a continuous contact between the peroxide and the polymer, that is to say that there are several injections or there is a continuous injection of the peroxide solution during the process.

Step a) for contacting may be carried out in any type of container. The container may be left open or may be closed after the contacting. The container may be closed in an airtight or non-airtight manner. Preferably, the container is closed in an airtight manner and is equipped with a valve.

Step b) is a step for the absorption, with stirring, of the peroxide solution by the polymer. Preferably, this is a complete absorption. The expression “complete absorption” is understood to mean that the remaining volume of nonabsorbed peroxide in the container after the absorption step is less than 5%, preferably less than 2%, most preferably less than 1%.

The period of absorption is generally within the range from 10 to 600 minutes, preferably from 20 to 240 minutes.

The absorption step is carried out with stirring. This stirring may be carried out by any stirring system, such as for example a paddle, propeller, screw or ultrasound system or in a device of the rotary or drum type, such as a drier.

During the third step of the process, the master batch is isolated, which master batch may be in the form of particles of copolymer comprising the peroxide.

Optionally, a step for drying the particles recovered during the third step may be carried out, for example in an oven or any other type of drier. This is preferably carried out at a temperature below the decomposition temperature of the peroxide of the composition.

The master batch may be used to manufacture the composition according to the invention.

According to one embodiment, the polymer of the master batch is a copolymer of ethylene and vinyl acetate and the polymer of the composition to be crosslinked is a copolymer of ethylene and vinyl acetate.

The composition or the film according to the invention may be used to encapsulate photovoltaic cells.

The photovoltaic cells which may be encapsulated may be of any type. These cells may be for example based on doped, monocrystalline or polycrystalline silicon, in a thin layer formed for example of amorphous silicon, cadmium telluride, copper-indium disilenide or alternatively based on organic materials.

The photovoltaic modules thus formed preferably comprise a front protective layer and a back protective layer.

The front protective layer preferably has abrasion and impact resistance properties, is transparent and protects the photovoltaic sensors from external moisture. To form this layer, mention may be made of glass, polymethyl methacrylate (PMMA) or any other polymer composition combining these characteristics.

The back protective layer essentially protects the module from moisture. It may comprise glass or alternatively fluorinated polymers such as polyvinyl fluoride (PVF) or polyvinylidene fluoride (PVDF).

To assemble the various layers, use may be made of all types of pressing technique such as for example hot pressing, vacuum pressing or laminating, in particular hot laminating. The manufacturing conditions will be easily determined by a person skilled in the art by adjusting the temperature and the pressure to the flow temperature of the composition.

The invention also relates to a process for the manufacture of a photovoltaic module comprising the steps:
of assembling the layers of photovoltaic cells, encapsulating film(s) and protective layers, at least one of the encapsulating films being a film according to the invention;
of curing the module, preferably at a temperature greater than or equal to the decomposition temperature of the peroxide.

To manufacture the photovoltaic modules with the composition or the film according to the invention, persons skilled in the art may also refer for example to the Handbook of Photovoltaic Science and Engineering, Wiley, 2003.

### EXAMPLES

Products used:

To formulate the examples of master batches according to the invention, the following products are used:

Copolymer: copolymer of ethylene and vinyl acetate comprising 33% by mass of vinyl acetate relative to its total mass.

Peroxide 1: tert-butyl 2-ethylperhexanoate.

Peroxide 2: OO-tert-butyl and O-(2-ethylhexyl)peroxycarbonate.

Crosslinking coagent: triallyl cyanurate.

Composition of the Master Batches:

The master batches according to the invention (MB 1) and comparative master batches (MB 2) have, relative to the total mass of the master batch, the following compositions:

| Products | MB1 | MB2 |
|---|---|---|
| Copolymer (%) | 90 | 90 |
| Peroxide 1 (%) | 10 | 0 |
| Peroxide 2 (%) | 0 | 10 |

Preparation of the Master Batches:

Absorption is carried out on the granules of copolymer for each of the solutions of peroxide.

The organic peroxide (2.2 kg) is brought into contact in a roller mixer with the copolymer (19.8 kg) optionally with the coupling agent and the crosslinking coagent in a closed container at 50° C., the axis of rotation of the cylinder being horizontal, and stirred by rotation of the container at a speed of 10 revolutions per minute.

A first half of the peroxide solution is injected at the start of the absorption and a second half is added after absorbing for 30 minutes.

The polymer particles are recovered after 120 minutes. The absorption of the peroxide solution into the particles is complete.

The particles were assayed after washing for one hour in n-heptane: the quantity of peroxide in the copolymer is 10% by total mass of the composition for MB1 and MB2.

Preparation of the Test Pieces

In order to evaluate the invention, films of a mixture of the constituents are prepared, that is to say the copolymer with the master batch MB1 or MB2 and optionally a crosslinking coagent. A premixing in a bag of the various constituents is carried out before mixing in an extruder. The films are then made by introducing this premixture into a counter-rotating twin screw Haake 1 extruder equipped with a film die. The temperature profile of the extruder is: hopper 20° C.—Zone 1: 75—Zone 2: 75—film die: 75° C., the speed of the screw 80 rpm. Films 8 cm wide are obtained.

Measurement of the Properties

The elastic modulus is measured with the aid of a controlled stress plate-plate type rotational rheometer of the Anton Paar brand, model Physica MCR301.

A sample of a film having a thickness of 0.5 mm approximately and a 25 mm diameter is placed between the two parallel plates which are heated by conduction. The oscillatory rotation of the top plate around the longitudinal axis applies a deformation to the sample placed between the two plates. The latter responds to this deformation by exerting a stress. The couple to be provided in order to maintain the deformation is then measured.

The experiment is started at 70° C. with a rise in temperature of 5° C.min⁻¹ up to 150° C., and then a plateau temperature is applied at 150° C. for 30 minutes. During the entire test, the elastic deformation modulus G′ is measured by applying a deformation of 0.2% at a frequency of 1 Hz (6.28 rad.s⁻¹), this modulus decreasing during the melting of the copolymer and then increasing during its crosslinking.

The criterion t₉₀ is defined, which represents the time taken to reach 90% of the final value of G′. Comparison of the t₉₀ values thus makes it possible to qualitatively classify the crosslinking speed of the films formulated.

The final value of G′ is also noted.

The same heat treatment is again carried out as before without applying stress and the number of bubbles/cm² (N) formed during the crosslinking is noted. The compositions of the films and the results obtained for these various compositions according to the invention (EX1 to EX7) or the comparative compositions (CP1 to CP3) are grouped together in the following table:

| | | | | | t₉₀ | Final G′ | | Presence of |
|---|---|---|---|---|---|---|---|---|
| Examples | Peroxide 1 | Peroxide 2 | Copolymer | Coagent | (s) | (MPa) | N | bubbles |
| EX1 | 1.6 | 0 | 98.4 | 0 | | | 7.1 | bubbles |
| EX2 | 1.6 | 0 | 97.9 | 0.5 | 780 | 2.30E+05 | | few |
| | | | | | | | | bubbles |
| EX3 | 1.6 | 0 | 97.4 | 1 | 804 | 2.87E+05 | | no |
| | | | | | | | | bubble |
| EX4 | 1.6 | 0 | 96.9 | 1.5 | 824 | 3.19E+05 | 1.2 | no |
| | | | | | | | | bubble |
| EX5 | 1.6 | 0 | 96.4 | 2 | 828 | 3.37E+05 | | no |
| | | | | | | | | bubble |
| EX6 | 1.6 | 0 | 95.9 | 2.5 | 840 | 3.74E+05 | | no |
| | | | | | | | | bubble |
| EX7 | 3 | 0 | 95 | 2 | 776 | 3.74E+05 | | no |
| | | | | | | | | bubble |
| CP1 | 0 | 1.5 | 98.5 | 0 | 1404 | 3.20E+05 | 1.6 | no |
| | | | | | | | | bubble |
| CP2 | 0 | 2 | 98 | 0 | 1392 | 4.46E+05 | | no |
| | | | | | | | | bubble |
| CP3 | 0 | 3 | 97 | 0 | 1380 | 4.65E+05 | | no |
| | | | | | | | | bubble |

The tests show that the peroxide according to the invention (peroxide 1) allows a more rapid crosslinking of the composition. This is particularly advantageous for its use as encapsulating composition in photovoltaic modules in order to increase the productivity of the photovoltaic modules. The tests also show that it is possible to reduce the number of bubbles formed during the crosslinking of the composition while further increasing the mechanical resistance of the crosslinked composition. This is also an advantage for its use as encapsulant for photovoltaic cells.

1. A system for the crosslinking of an ethylene copolymer and an ethylene monomer bearing a polar functional group comprising at least:
one organic peroxide whose half-life is equal to one hour for any temperature chosen in the range from 80° C. to 115° C.;
and one crosslinking coagent;
the half-life of said peroxide being measured by dissolving it in n-dodecane at a concentration of 0.2 mol/L.

2. The crosslinking system as claimed in claim 1, in which the organic peroxide is chosen from tert-butyl 2-ethylperhexanoate, tert-amyl 2-ethylperhexanoate, 1,1-di-(tert-butylperoxy)-3,3,5-trimethylcyclohexane, bisdecanoyl peroxide and dilauroyl peroxide.

3. The system as claimed in claim 1, in which the crosslinking coagent is chosen from triallyl cyanurate, triallyl isocyanurate, triallyl trimellitate and trimethylolpropane trimethacrylate.

4. The system as claimed in claim 1, in which the ratio by mass of organic peroxide and crosslinking coagent is within the range from 1:10 to 10:1.

5. The use of the system as claimed in claim 1, for the crosslinking of an ethylene copolymer and an ethylene comonomer bearing a polar functional group.

6. A composition comprising at least one polymer and the system as claimed in claim 1.

7. The composition as claimed in claim 6, in which the polymer is a copolymer of ethylene and an ethylene monomer bearing a polar functional group.

8. The composition as claimed in claim 7, in which the ethylene monomer is chosen from vinyl acetate and methyl, ethyl or butyl(meth)acrylates.

9. The composition as claimed in claim 7, in which the copolymer comprises from 10 to 60% by mass of ethylene monomer bearing a polar functional group relative to the total mass of the copolymer.

10. The composition as claimed in claim 6, in which the quantity of crosslinking system is preferably within, relative to the total weight of the composition, the range from 0.1 to 10%.

11. A film comprising a composition as claimed in claim 6.

12. An encapsulant in a photovoltaic module comprising the film as claimed in claim 11.

13. A process for the manufacture of a composition as claimed in claim 6, comprising a stage for mixing organic peroxide, crosslinking coagent and polymer, it being possible for this stage to be carried out in one or more steps.

14. The process for the manufacture of a composition as claimed in claim 13, comprising a step for mixing a master batch comprising the organic peroxide, polymer and the crosslinking coagent.

15. A master batch comprising:
a copolymer of ethylene and an ethylene monomer bearing a polar functional group;
and at least one organic peroxide chosen from peroxides having an organic peroxide whose half-life, measured by dissolving it in n-dodecane at a concentration of 0.2 mol/L, is equal to one hour for any temperature chosen from the range from 80° C. to 115° C.;
the quantity by mass of peroxide being within the range from 5 to 30% relative to the total weight of the master batch.

16. A process for the manufacture of the master batch as claimed in claim 15,
a. a step for contacting the peroxide;
b. a step for the absorption of the peroxide by the polymer in order to form a master batch;
c. a step for isolating said master batch.

17. The composition as claimed in claim 6, in which the polymer is a polyolefin.

18. The composition as claimed in claim 7, the ethylene monomer comprising from 3 to 20 carton atoms.

19. The master batch as claimed in claim 15, in which the organic peroxide is chosen from tert-butyl 2-ethylperhexanoate, tert-amyl 2-ethylperhexanoate, 1,1-di-(tert-butylperoxy)-3,3,5-trimethylcyclohexane, bisdecanoyl peroxide and dilauroyl peroxide.
